(19) United States
(12) Patent Application Publication
(10) Pub. No.: US 2022/0083868 A1
(43) Pub. Date: Mar. 17, 2022

(54) NEURAL NETWORK TRAINING METHOD AND APPARATUS, AND ELECTRONIC DEVICE

(71) Applicant: NANJING INSTITUTE OF ADVANCED ARTIFICIAL INTELLIGENCE, LTD., Nanjing, Jiangsu (CN)

(72) Inventors: Helong ZHOU, Nanjing, Jiangsu (CN); Qian ZHANG, Nanjing, Jiangsu (CN); Chang HUANG, Nanjing, Jiangsu (CN)

(73) Assignee: NANJING INSTITUTE OF ADVANCED ARTIFICIAL INTELLIGENCE, LTD., Nanjing, Jiangsu (CN)

(21) Appl. No.: 17/421,446

(22) PCT Filed: Aug. 16, 2019
(86) PCT No.: PCT/CN2019/100983

§ 371 Date: Jul. 8, 2021

(30) Foreign Application Priority Data
Jan. 8, 2019 (CN) 201910015326.4

(51) Int. Cl. G06N 3/08; G06N 3/04

(52) U.S. Cl. CPC G06N 3/084; G06N 3/0454

(57) ABSTRACT

A neural network training method comprises: inputting training data into trained first neural network and second neural network to be trained; determining first feature map output by a preset layer of the first neural network and second feature map output by the second neural network at the preset layer; determining a first loss function value of the second neural network on the basis of the first feature map and the second feature map; updating parameters of the second neural network on the basis of the first loss function value and a second loss function value of the second neural network; and taking the updated parameters of the second neural network as initial parameters of the second neural network to be trained, updating the parameters of the second neural network in an iterative manner, and if the updated second neural network meets a preset condition, obtaining final trained second neural network.

### CROSS-REFERENCE TO RELATED APPLICATIONS

The present disclosure claims benefit of and priority to Chinese Patent Application No. 201910015326.4 filed on Jan. 8, 2019, entitled “NEURAL NETWORK TRAINING METHOD AND APPARATUS, AND ELECTRONIC DEVICE,” the disclosure of which is hereby expressly incorporated by reference herein in its entirety.

### TECHNICAL FIELD

The present disclosure relates to the field of deep learning technology, and more specifically, to a neural network training method and apparatus, and an electronic device.

### BACKGROUND

A deep neural network with good performance usually has a relatively deep number of layers, resulting in a huge amount of network parameters. When the deep neural network is applied on a mobile terminal, usually a lightweight network with smaller model parameters is chosen, however, the performance of the lightweight network is relatively not so good.

Among the techniques to improve the model performance of lightweight networks, knowledge distillation is widely used as an effective means. The working principle of the knowledge distillation is to use the output of a large model as an auxiliary annotation to further effectively supervise the training of the lightweight network and realize the knowledge transfer.

However, traditional knowledge distillation has not fully transferred the knowledge of large networks to lightweight networks, and there is still room for improvement in the precision of lightweight networks.

Therefore, it is desirable to provide an improved generation scheme for the lightweight network.

### SUMMARY

In order to solve the above technical problems, the present disclosure is proposed. Embodiments of the application provide a neural network training method and apparatus, and an electronic device, which can combine a trained and an untrained neural network to obtain a loss function based on feature maps of the same preset layer, and further combine a loss function of the untrained neural network itself to update parameters of the untrained neural network, thereby improving the precision of the neural network after trained.

According to an aspect of the present disclosure, there is provided a neural network training method comprising: inputting training data into a trained first neural network and a to-be-trained second neural network; determining a first feature map output by a preset layer of the first neural network and a second feature map output by the second neural network at the preset layer; determining a first loss function value (FLFV) of the second neural network based on the first feature map and the second feature map; updating parameters of the second neural network based on the first loss function value and a second loss function value (SLFV) of the second neural network; and taking the parameters of the updated second neural network as initial parameters of the to-be-trained second neural network, repeating, in an iterative manner, the step of inputting the training data into the trained first neural network and the to-be-trained second neural network to the step of updating the parameters of the second neural network based on the first loss function value and the second loss function value of the second neural network, obtaining a final trained second neural network when the second neural network obtained after updated meets a preset condition.

According to another aspect of the present disclosure, there is provided a neural network training apparatus comprising: a neural network input unit for inputting training data into a trained first neural network and a to-be-trained second neural network; a feature map determining unit for determining a first feature map output by a preset layer of the first neural network input by the neural network input unit and a second feature map output by the second neural network input by the neural network input unit at the preset layer; a function loss determining unit for determining a first loss function value of the second neural network based on the first feature map and the second feature map determined by the feature map determining unit; a neural network updating unit for updating parameters of the second neural network based on the first loss function value, and a second loss function value of the second neural network determined by the loss function determining unit; and an iterative updating unit for taking the updated parameters of the second neural network as initial parameters of the to-be-trained second neural network, repeating in an iterative manner the above-mentioned step of inputting the training data into the trained first neural network and the to-be-trained second neural network to the step of updating the parameters of the second neural network based on the first loss function value and the second loss function value of the second neural network, obtaining a final trained second neural network when the second neural network obtained after updated meets a preset condition.

According to another aspect of the present disclosure, there is provided an electronic device comprising: a processor; and a memory having computer program instructions stored thereon, the computer program instructions, when executed by the processor, causing the processor to execute the neural network training method as described above.

According to another aspect of the present disclosure, there is provided a computer readable medium having computer program instructions stored thereon, the computer program instructions, when executed by a processor, causing the processor to execute the neural network training method as described above.

Compared with the prior art, the neural network training method, the neural network training apparatus and the electronic device according to the present disclosure can input training data into the trained first neural network and the to-be-trained second neural network; determine the first feature map output by the preset layer of the first neural network and the second feature map output by the second neural network at the preset layer; determine the first loss function value of the second neural network based on the first feature map and the second feature map; update the parameters of the second neural network based on the first loss function value, and the second loss function value of the second neural network; use the parameters of the updated second neural network as the initial parameters of the to-be-trained second neural network, repeat in an iterative manner the above-mentioned steps of inputting training data into the trained first neural network and the to-be-trained second neural network to the step of updating the parameters of the second neural network based on the first loss function value and the second loss function value of the second neural network, and obtain a final trained second neural network when the updated second neural network meets a preset condition.

In this way, by combining the feature map output by the trained first neural network and the to-be-trained second neural network at the preset layer to determine the loss function value, and further combining the loss function value of the second neural network itself to update the parameters of the second neural network, and using the updated parameters of the second neural network as the initial parameters of the to-be-trained second neural network and updating the second neural network in an iterative manner, the second neural network can be trained by fully and effectively utilizing the parameters of the trained first neural network, so as to improve the precision of the second neural network.

### BRIEF DESCRIPTION OF THE DRAWINGS

Through a more detailed description of the embodiments of the present disclosure in conjunction with the accompanying drawings, the above and other objectives, features, and advantages of the present disclosure will become more apparent. The accompanying drawings are used to provide a further understanding of the embodiments of the application, and constitute a part of the specification. Together with the embodiments of the application, the drawings are used to explain the application, and do not constitute a limitation to the application. In the drawings, the same reference numerals generally represent the same components or steps.

FIG. 1 illustrates a flowchart of a neural network training method according to an embodiment of the present disclosure.

FIG. 2 illustrates a schematic diagram of an iterative process of a neural network training method according to an embodiment of the present disclosure.

FIG. 3 illustrates a schematic diagram of a neural network training method according to an embodiment of the present disclosure when it is applied to an image recognition and detection scenario.

FIG. 4 illustrates a flowchart of the process of determining a feature map and a loss function of the neural network training method according to an embodiment of the present disclosure in an image recognition and detection scenario.

FIG. 5 illustrates a schematic diagram of a neural network training method according to an embodiment of the present disclosure when it is applied to a classification scenario.

FIG. 6 illustrates a flowchart of the process of determining the feature map and loss function of the neural network training method according to an embodiment of the present disclosure in a classification scenario.

FIG. 7 illustrates a flowchart of a training example of the second neural network in the neural network training method according to an embodiment of the present disclosure.

FIG. 8 illustrates a block diagram of a neural network training apparatus according to an embodiment of the present disclosure.

FIG. 9 illustrates a block diagram of a first example of the neural network training apparatus according to an embodiment of the present disclosure in an image recognition and detection scenario.

FIG. 10 illustrates a block diagram of a second example of the neural network training device according to an embodiment of the present disclosure in a classification scenario.

FIG. 11 illustrates a block diagram of a schematic neural network updating unit of a neural network training device according to an embodiment of the present disclosure.

FIG. 12 illustrates a block diagram of an electronic device according to an embodiment of the present disclosure.

### DETAILED DESCRIPTION

Hereinafter, exemplary embodiments according to the present disclosure will be described in detail with reference to the accompanying drawings. Obviously, the described embodiments are only a part of the embodiments of the present disclosure, rather than all the embodiments of the present disclosure, and it should be understood that the present disclosure is not limited by the exemplary embodiments described herein.

Overview

As described above, knowledge transfer from a large network to a lightweight network can be realized through knowledge distillation. Moreover, the degree of knowledge transfer determines the precision of the lightweight network, that is, the precision of the generated lightweight network is insufficient if the knowledge transfer is insufficient.

Regarding the above technical problem, the basic concept of the present disclosure is to determine a loss function value by combining feature maps output by a trained neural network and by a to-be-trained neural network at a preset layer, and further combining a loss function value of the to-be-trained neural network to update parameters of the to-be-trained neural network in an iterative manner.

Specifically, the neural network training method, the neural network training apparatus, and the electronic equipment provided in the present disclosure firstly input training data into the trained first neural network and the to-be-trained second neural network, then determine a first feature map output by a preset layer of the first neural network and a second feature map output by the second neural network at the preset layer, then determine a first loss function value of the second neural network based on the first feature map and the second feature map, and then update parameters of the second neural network based on the first loss function value and the second loss function value of the second neural network, finally use the updated parameters of the second neural network as initial parameters of the to-be-trained second neural network, and repeat in an iterative manner the above-mentioned step of inputting training data into the trained first neural network and the to-be-trained second neural network to the step of updating the parameters of the second neural network based on the first loss function value and the second loss function value of the second neural network, and obtain a final trained second neural network when the second neural network obtained after updated meets a preset condition.

In this way, because the updating of the parameters of the second neural network depends on its own second loss function value and the first loss function value determined by combining the feature maps output by the preset layer of the trained first neural network and the to-be-trained second neural network at the preset layer, and the second neural network is updated in an iterative manner by using the updated parameters of the second neural network as the initial parameters of the to-be-trained second neural network, therefore in the training process of the neural network, the parameters of the trained first neural network can be fully and effectively used, thereby improving the precision of the second neural network after trained.

It shall be noted that although the knowledge distillation from a large network to a lightweight network has been described above as an example, the neural network training method, the neural network training apparatus and the electronic device according to the present disclosure can essentially be used in knowledge transfer between a variety of neural networks, for example, both the trained first neural network and the to-be-trained second neural network can be large networks or lightweight networks, and the present disclosure does not intend to impose any restrictions on this.

After introducing the basic principle of the present disclosure, various non-limiting embodiments of the present disclosure will be described in detail below with reference to the accompanying drawings.

Exemplary Method

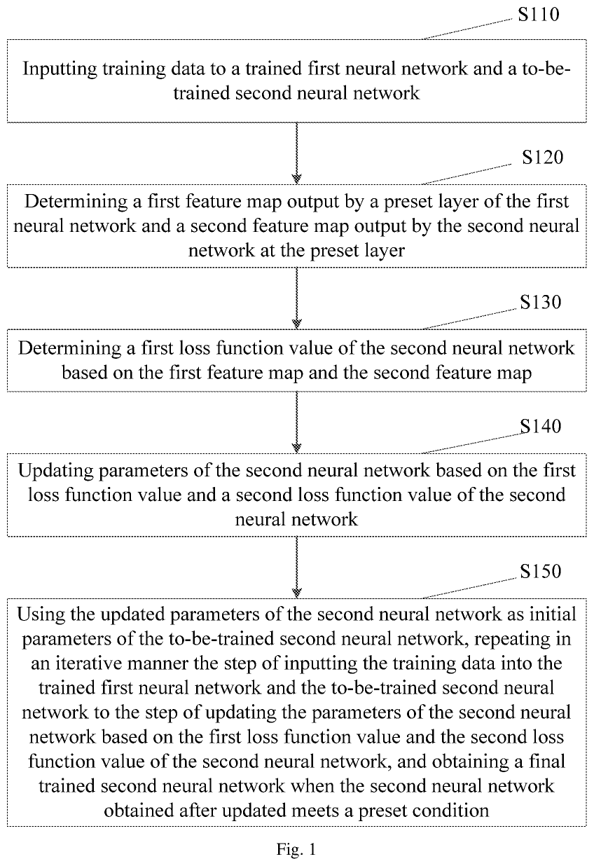

FIG. 1 illustrates a flowchart of a neural network training method according to an embodiment of the present disclosure.

As shown in FIG. 1, the neural network training method according to the embodiment of the present disclosure comprises the following steps.

In step S110, training data is input to a trained first neural network and a to-be-trained second neural network. Here, the first neural network and the second neural network may be various types of neural networks used for image recognition, object detection, object classification, etc. Correspondingly, the training data may be an image training set.

Moreover, as described above, in the embodiment of the present disclosure, the trained first neural network may be a large network with a large amount of parameters and high precision, and the to-be-trained second neural network may be a lightweight network with a small amount of parameters and relatively low precision. Therefore, in order to improve the precision of the lightweight network, the large network after trained is necessary for providing a supervision signal to guide the lightweight network how to learn.

Here, the first neural network is already trained before the training data is input, that is, the first neural network is trained to converge. The second neural network corresponds to the first neural network, so that the trained first neural network can be used for training the second neural network, and the second neural network obtains the initialized parameters through Gaussian initialization.

That is to say, in the neural network training method according to the embodiment of the present disclosure, before inputting the training data into the trained first neural network and the to-be-trained second neural network, it further comprises: training the first neural network until the first neural network converges; and performing Gaussian initialization on the second neural network corresponding to the first neural network.

In this way, the trained first neural network can provide a supervisory signal to supervise the training of the second neural network by training the first neural network and initializing the second neural network. The knowledge transfer between neural networks is realized, and the precision of the second neural network is improved.

In step S120, a first feature map output by a preset layer of the first neural network and a second feature map output by the second neural network at the preset layer are determined. In other words, in order that the first neural network provides the supervision signal to supervise the training of the second neural network, it is necessary to extract the output feature maps from the same layer of the first neural network and the second neural network. Here, according to the specific model types of the first neural network and the second neural network, such as a face recognition model, an object detection model, a classification model, etc., the preset layer may be various preset layers of the network model, which will be explained in further detail later.

In step S130, a first loss function value of the second neural network is determined based on the first feature map and the second feature map. As mentioned above, since the first neural network and the second neural network can be various models, the extracted first feature map and the extracted second feature map output at the preset layer may also be different feature maps, therefore, the first loss function value determined based on the first feature map and the second feature map may also be different types of loss function values, which will also be described in further detail later.

In step S140, parameters of the second neural network are updated based on the first loss function value and a second loss function value of the second neural network. Because the first loss function value is determined based on the first feature map output by the first neural network at the preset layer and the second feature output by the second neural network at the preset layer, the first loss function value may be used as the supervision signal provided by the first neural network. Moreover, by further combining the second loss function value of the second neural network itself to update the parameters of the second neural network, the knowledge transfer of the parameters of the first neural network can be realized, thereby improving the precision of the updated second neural network.

In step S150, the updated parameters of the second neural network are used as initial parameters of the to-be-trained second neural network, the step of inputting the training data into the trained first neural network and the to-be-trained second neural network to the step of updating the parameters of the second neural network based on the first loss function value and the second loss function value of the second neural network are repeated in an iterative manner, and a final trained second neural network is thus obtained when the second neural network obtained after updated meets a preset condition.

That is to say, in the neural network training method according to the embodiment of the present disclosure, in order to further improve the precision of the second neural network after trained, the second neural network obtained in this training can be used as the untrained second neural network in step S110, the trained parameters are used as the initial parameters, and thus steps S110 to S140 in the embodiment shown in FIG. 1 are repeatedly executed. After multiple iterations, the second neural network that meets a certain precision is obtained. Therefore, through an iterative distillation method, the neural network after the previous distillation is used as the initialization of the neural network to be trained in this training process, and the second neural network is continuously distilled through the trained first neural network, thereby making the knowledge of the first neural network being the large network is fully transferred to the second, lightweight neural network.

In this way, by using the trained parameters of the second neural network as the initial parameters of the second neural network in the next iteration, the supervisory signal provided by the first neural network can be fully utilized, and the precision of the second neural network can be further improved.

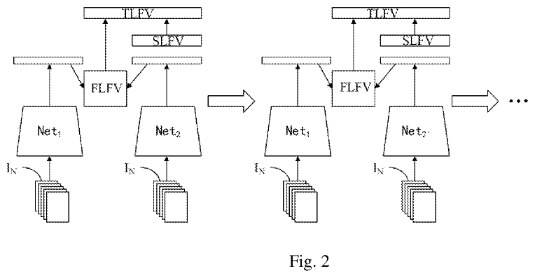

FIG. 2 illustrates a schematic diagram of an iterative process in a neural network training method according to an embodiment of the present disclosure.

As shown in FIG. 2, the training data, such as an image set IN, is input into the trained first neural network Net1 and the to-be-trained second neural network Net2, and the updated parameters of the second neural network is obtained by training on the basis of the neural network training method as described above.

Next, the trained first neural network Net1 remains as it is, and the updated parameters of the second neural network are used as the parameters of the to-be-trained second neural network, that is, the updated second neural network serves as a pre-training model of the to-be-trained second neural network, and the second neural network Net2′ is trained by inputting, for example, an image set IN.

Continue the above iterative process until the updated second neural network meets the preset condition. Specifically, in the iterative process, the precision of the updated second neural network can be determined, and the iteration will not stop until the precision of the two adjacent updated models has no significant difference.

That is, in the neural network training method according to the embodiment of the present disclosure, the step of obtaining the final trained second neural network when the second neural network obtained after updated meets a preset condition comprises: obtaining first test precision of the second neural network before updating and second test precision of the updated second neural network; determining whether a difference between the first test precision and the second test precision is less than a predetermined threshold; and, in response to the difference between the first test precision and the second test precision being less than the predetermined threshold, determining that the training of the second neural network is completed.

Therefore, by setting the iteration termination condition, the iteration updating of the second neural network can be effectively performed to improve training efficiency.

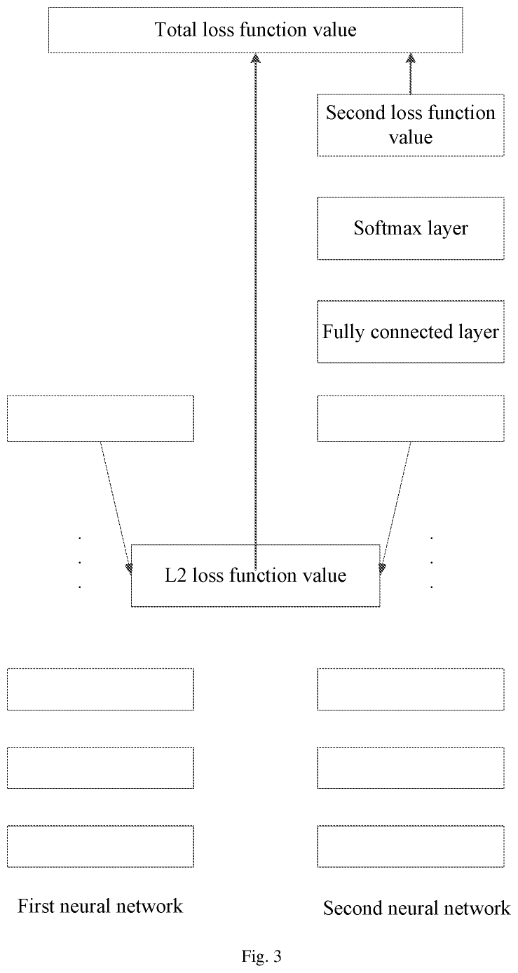

FIG. 3 illustrates a schematic diagram of a neural network training method according to an embodiment of the present disclosure applied to image recognition and detection scenarios.

As shown in FIG. 3, when applied to image recognition and detection, such as face recognition and object detection scenarios, the feature maps output by the last layers of the convolutional layers of the first neural network and the second neural network are extracted. Moreover, a L2 loss function value of the second neural network is calculated through the first feature map and the second feature map, and then combined with the loss function value of the second neural network itself to calculate the total loss function value (TLFV).

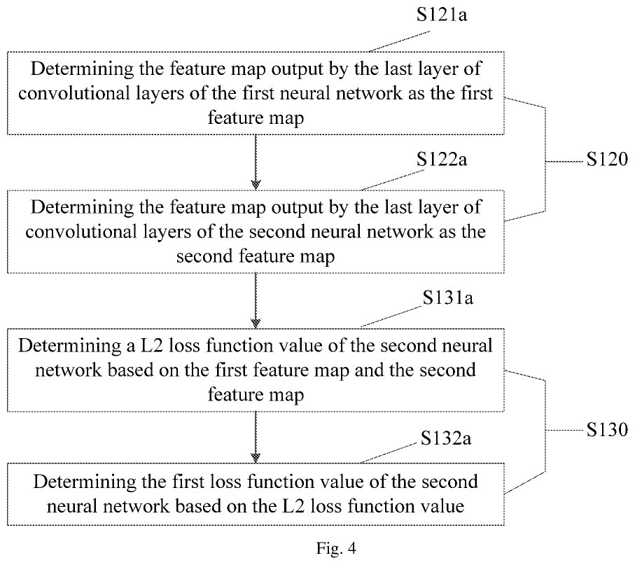

FIG. 4 illustrates a flowchart of the process of determining a feature map and a loss function of a neural network training method according to an embodiment of the present disclosure in an image recognition and detection scenario.

As shown in FIG. 4, on the basis of the embodiment shown in FIG. 1, the step S120 may comprise the following steps.

In step S121a, the feature map output by the last layer of convolutional layers of the first neural network, that is, the output of last convolutional layer of the first neural network shown in FIG. 2, is determined as the first feature map.

In step S122a, the feature map output by the last layer of convolutional layers of the second neural network, that is, the output of the last convolutional layer of the second neural network shown in FIG. 2, is determined as the second feature map.

Moreover, as further shown in FIG. 4, on the basis of the embodiment shown in FIG. 1, the step S130 may comprise the following steps.

In step S131a, a L2 loss function value of the second neural network, that is, as shown in FIG. 3, the L2 loss function value calculated from the output of the last convolutional layer of the first neural network and the second neural network, is determined based on the first feature map and the second feature map.

In step S132a, the first loss function value of the second neural network is determined based on the L2 loss function value, for example, the L2 loss function value may be multiplied by a predetermined weighting coefficient to obtain the first loss function value of the second neural network.

In this way, the neural network training method according to the embodiments of the present disclosure can be used to the training to neural network models for image recognition and detection, such as face recognition and object detection, thereby improving the precision of the neural network, and improving the precision of image recognition and detection.

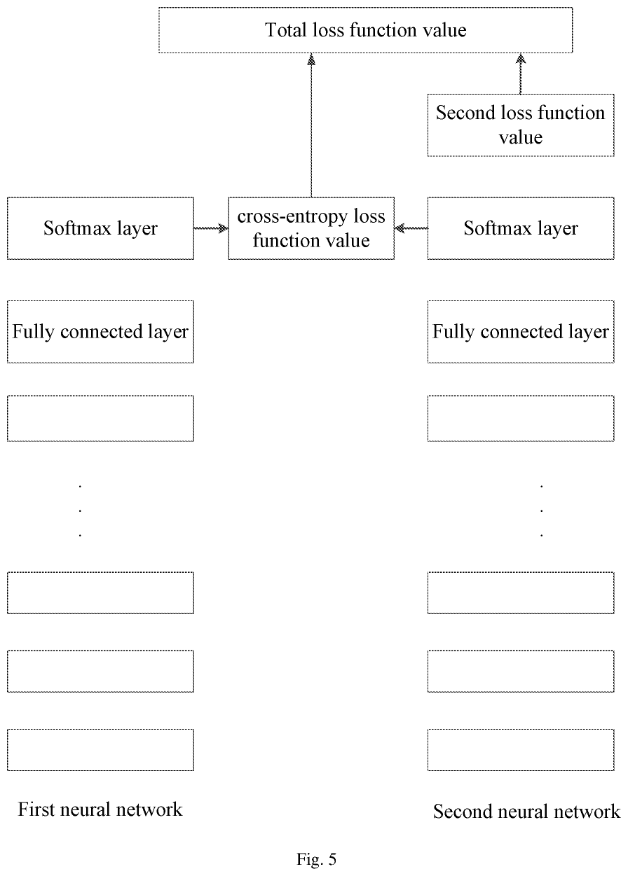

FIG. 5 illustrates a schematic diagram of a neural network training method according to an embodiment of the present disclosure applied to a classification scenario.

As shown in FIG. 5, when the neural network training method is applied to a classification scenario, such as an object classification scenario based on an image, the feature maps output by the last layers of a softmax layers of the first neural network and the second neural network are extracted. Here, those skilled in the art can understand that although in FIG. 4 it is shown that a fully connected layer is comprised between the last layer of the convolutional layer and the softmax layer, the first neural network and the second neural network may also does not comprise the fully connected layer.

Then, a cross-entropy loss function value of the second neural network is calculated through the first feature map and the second feature map, and then combined with the loss function value of the second neural network itself to calculate the total loss function value.

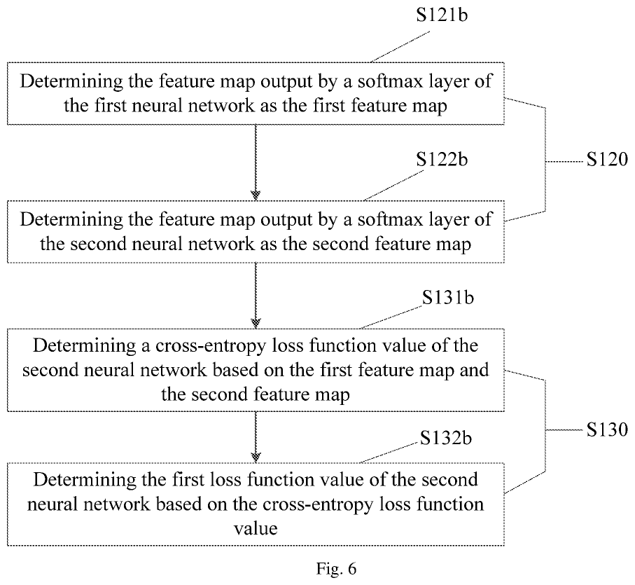

FIG. 6 illustrates a flowchart of the process of determining the feature map and the loss function of the neural network training method according to an embodiment of the present disclosure in a classification scenario.

As shown in FIG. 6, based on the embodiment shown in FIG. 1, the step S120 may comprise the following steps.

In step S121b, a feature map output by a softmax layer of the first neural network, that is, the output of the softmax layer of the first neural network as shown in FIG. 4, is determined to be the first feature map.

In step S122b, a feature map output by a softmax layer of the second neural network, that is, the output of the softmax layer of the second neural network as shown in FIG. 4, is determined to be the second feature map.

Moreover, as further shown in FIG. 6, on the basis of the embodiment shown in FIG. 1, the step S130 may comprise the following steps.

In step S131b, a cross-entropy loss function value of the second neural network, that is, the cross-entropy loss function value calculated based on the output of the softmax layer of the first neural network and the second neural network as shown in FIG. 5, is determined based on the first feature map and the second feature map.

In step S132b, the first loss function value of the second neural network is determined based on the cross-entropy loss function value. For example, the cross-entropy loss function value may be multiplied by a predetermined weighting coefficient to obtain the first loss function value of the second neural network.

In this way, the neural network training method according to the embodiment of the present disclosure can be used to the training to neural network models for classification, such as an image-based object classification, so as to improve the precision of the neural network, thereby improving the precision of object classification.

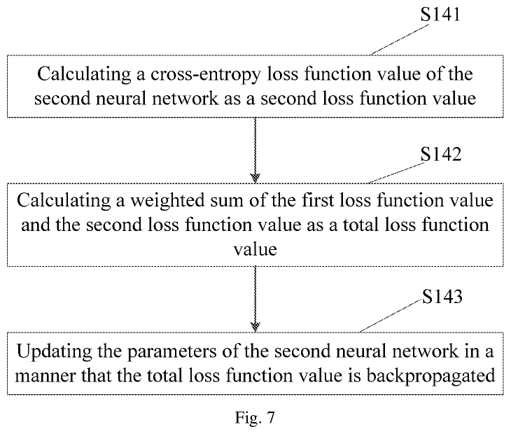

FIG. 7 illustrates a flowchart of a training example of the second neural network in the neural network training method according to an embodiment of the present disclosure.

As shown in FIG. 7, based on the embodiment shown in FIG. 1, the step S140 may comprise the following steps.

In step S141, the cross-entropy loss function value of the second neural network is calculated as the second loss function value, that is, for the loss function value of the second neural network itself, the cross-entropy loss function value can be calculated. Of course, those skilled in the art can understand that other types of loss function values can also be calculated.

In step S142, a weighted sum of the first loss function value and the second loss function value is calculated as a total loss function value. Similarly, those skilled in the art can understand that the first loss function value and the second loss function value can also be combined in other ways to calculate the total loss function value.

In step S143, the parameters of the second neural network are updated in a manner that the total loss function value is backpropagated. At this time, the parameters of the second neural network are updated, while the parameters of the first neural network remain unchanged.

Therefore, by combining the first loss function value determined based on the feature maps of the first neural network and the second neural network to update the parameters of the second neural network by way of back propagation, the trained parameters of the first neural network could be fully used during the training process of the second neural network training, thereby improving the training precision.

Exemplary Apparatus

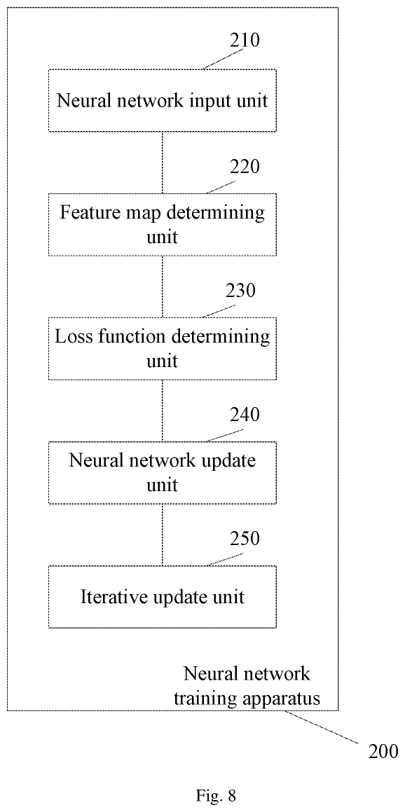

FIG. 8 illustrates a block diagram of a neural network training apparatus according to an embodiment of the present disclosure.

As shown in FIG. 8, the neural network training apparatus 200 according to the embodiment of the present disclosure comprises: a neural network input unit 210 for inputting training data into a trained first neural network and a second neural network to be trained; a feature map determining unit 220 for determining a first feature map output by a preset layer of the first neural network input by the neural network input unit 210 and a second feature output by the second neural network input by the neural network input unit 210 at the preset layer; a loss function determining unit 230 for determining a first loss function value of the second neural network based on the first feature map and the second feature map determined by the feature map determining unit 220; a neural network update unit 240 for updating parameters of the second neural network based on the first loss function value determined by the loss function determining unit 230 and a second loss function value of the second neural network; and an iterative update unit 250 for using the parameters of the second neural network updated by the neural network update unit 240 as initial parameters of the to-be-trained second neural network, repeating in an iterative manner of the step of inputting the training data into the trained first neural network and the to-be-trained second neural network input by the neural network input unit 210 to the step of updating the parameters of the second neural network based on the first loss function value and the second loss function value of the second neural network updated by the neural network update unit 240, and obtaining a final trained second neural network when the second neural network obtained after updated meets a preset condition.

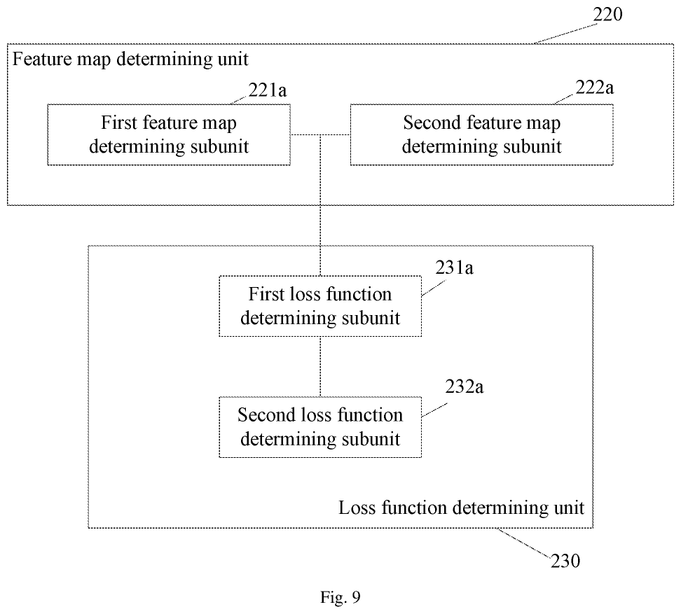

FIG. 9 illustrates a block diagram of a first example of the neural network training apparatus according to an embodiment of the present disclosure in an image recognition and detection scenario.

As shown in FIG. 9, on the basis of the embodiment shown in FIG. 8, the feature map determining unit 220 includes: a first feature map determining subunit 221a for determining the feature map output by the last layer of the convolutional layers of the first neural network input by the neural network input unit 210 as the first feature map, and a second feature map determining subunit 222a for determining the feature map output by the last layer of the convolutional layers of the second neural network input by the neural network input unit 210 as the second feature map; and the loss function determining unit 230 includes: a first loss function determining subunit 231a for determining a L2 loss function value of the second neural network based on the first feature map determined by the first feature map determining subunit 221a and the second feature map determined by the second feature map determining subunit 222a, and a second loss function determining subunit 232a for determining the first loss function value of the second neural network input by the neural network input unit 210 based on the L2 loss function value determined by the first loss function determining subunit 231a.

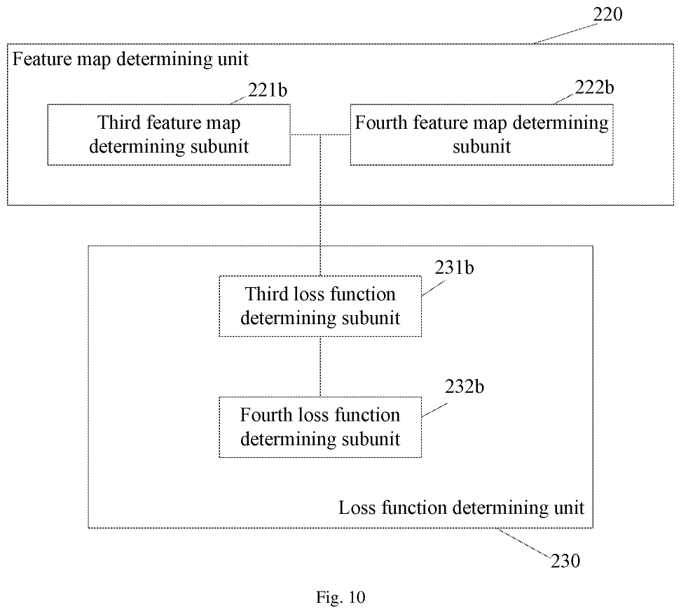

FIG. 10 illustrates a block diagram of a second example of the neural network training apparatus according to an embodiment of the present disclosure in a classification scenario.

As shown in FIG. 10, on the basis of the embodiment shown in FIG. 8, the feature map determining unit 220 includes: a third feature map determining subunit 221b, which is used to determine a feature map output by a softmax layer of the first neural network input by the neural network input unit 210 as the first feature map, and a fourth feature map determining subunit 222b, which is configured to determine a feature map output by a softmax layer of the second neural network input by the neural network input unit 210 as the second feature map; and the loss function determining unit 230 includes: a third loss function determining subunit 231b, which is configured to determine a cross-entropy loss function value of the second neural network based on the first feature map determined by the third feature map determining subunit 221b and the second feature map determined by the fourth feature map determining subunit 222b, and a fourth loss function determining subunit 232b, which is configured to determine the first loss function value of the second neural network input by the neural network input unit 210 based on the cross-entropy loss function value determined by the third loss function determining subunit 231b.

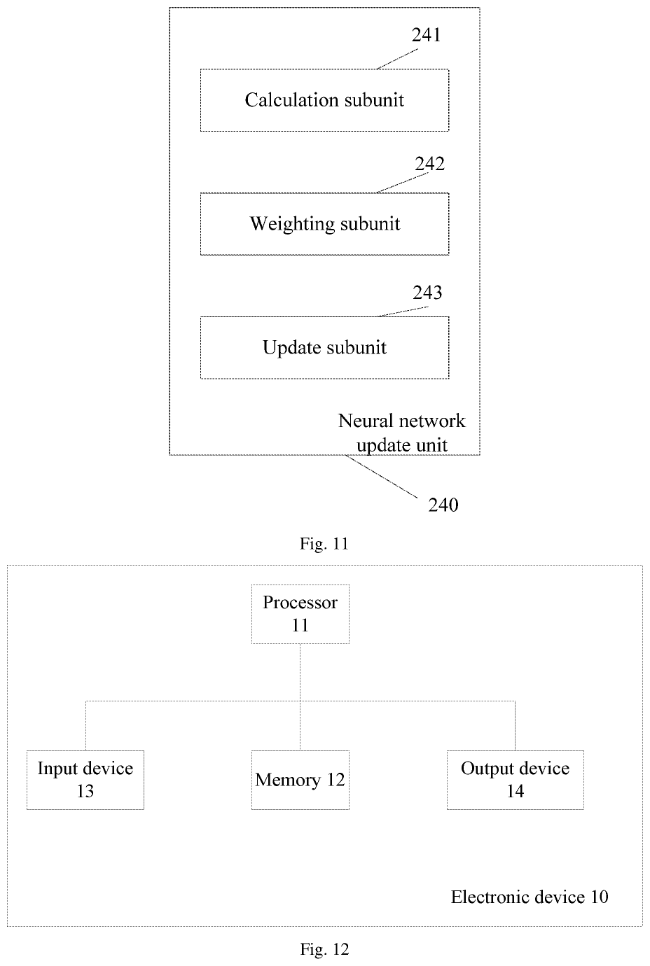

FIG. 11 illustrates a block diagram of a schematic neural network update unit of a neural network training apparatus according to an embodiment of the present disclosure.

As shown in FIG. 11, on the basis of the embodiment shown in FIG. 8, the neural network updating unit 240 includes: a calculation subunit 241 for calculating the cross-entropy loss function value of the second neural network as the second loss function value; a weighting subunit 242 for calculating a weighted sum of the first loss function value determined by the loss function determining unit 230 and the second loss function value calculated by the calculation subunit 241 as the total loss function value; and an updating subunit 243 for updating the parameters of the second neural network in a backpropagation manner using the total loss function value calculated by the weighting subunit 242.

In an example, the above-mentioned neural network training apparatus 200 further comprises a preprocessing unit for training the first neural network until the first neural network converges, and performing Gaussian initialization on the second neural network corresponding to the first neural network.

Here, those skilled in the art can understand that the specific functions and operations of the various units and modules in the above-mentioned neural network training apparatus 200 have been introduced in detail in the description of the neural network training method with reference to FIGS. 1 to 7. And therefore, the repeated description will be omitted.

As described above, the neural network training apparatus 200 according to the embodiment of the present disclosure can be implemented in various terminal equipments, such as a server used for face recognition, object detection, or object classification. In an example, the neural network training apparatus 200 according to the embodiment of the present disclosure can be integrated into the terminal equipment as a software module and/or hardware module. For example, the neural network training apparatus 200 can be a software module in the operating system of the terminal equipment, or it can be an application developed for the terminal equipment. Of course, the neural network training apparatus 200 can also be one of the many hardware modules of this terminal equipment.

Alternatively, in another example, the neural network training apparatus 200 and the terminal equipment may be separate equipment, and the neural network training apparatus 200 may be connected to the terminal equipment through a wired and/or wireless network, and may transmit interactive information with the terminal equipment in accordance with the agreed data format.

Exemplary Electronic Device

Hereinafter, an electronic device according to an embodiment of the present disclosure will be described with reference to FIG. 12.

FIG. 12 illustrates a block diagram of an electronic device according to an embodiment of the present disclosure.

As shown in FIG. 12, the electronic device 10 comprises one or more processors 11 and a memory 12.

The processor 13 may be a central processing unit (CPU) or another form of processing unit with data processing capability and/or instruction execution capability, and may control other components in the electronic device 10 to perform desired functions.

The memory 12 may include one or more computer program products, which may comprise various forms of computer-readable storage media, such as volatile memory and/or non-volatile memory. The volatile memory may include, for example, a random access memory (RAM) and/or a cache memory (cache). The non-volatile memory may include, for example, a read-only memory (ROM), a hard disk, a flash memory, and the like. One or more computer program instructions may be stored on the computer-readable storage medium, and the processor 11 may run the program instructions to implement the neural network training methods of the various embodiments according to the present disclosure described above and/or other desired functions. Various contents such as the first feature map, the second feature map, the first loss function value, and the second loss function value, can also be stored in the computer-readable storage medium.

In an example, the electronic device 10 may further comprise an input device 13 and an output device 14, and these components are interconnected by a bus system and/or other forms of connection mechanisms (not shown).

The input device 13 may comprise, for example, a keyboard, a mouse, and so on.

The output device 14 can output various information to the outside, comprising the second neural network that has completed the training, and so on. The output device 14 may include, for example, a display, a speaker, a printer, a communication network and a remote output equipment connected thereto, and so on.

Of course, for simplicity, only some of the components of the electronic device 10 related to the present disclosure are shown in FIG. 12, and components, such as buses, input/output interfaces, etc. are omitted. In addition, according to specific application conditions, the electronic equipment 10 may also comprise any other appropriate components.

Exemplary Computer Program Product and Computer Readable Storage Medium

In addition to the above-mentioned methods and apparatuses, the embodiments of the present disclosure may also be computer program products having computer program instructions stored thereon. The computer program instructions, when executed by a processor, cause the processor to execute the steps of the neural network training methods according to various embodiments of the present disclosure described in the part “exemplary method” described above in this specification.

The computer program product can be used to write program codes for performing the operations of the embodiments of the present disclosure in any combination of one or more programming languages. The programming languages include object-oriented programming languages, such as Java, C++, etc., in addition to conventional procedural programming languages, such as “C” language or similar programming languages. The program code can be executed entirely on the user's computing device, partly executed on the user's device, executed as an independent software package, partly executed on the user's computing device and partly executed on the remote computing device, or entirely executed on the remote computing device or servicer.

In addition, the embodiment of the present disclosure may also be a computer-readable storage medium, on which computer program instructions are stored. When the computer program instructions are executed by a processor, the processor is forced to execute the steps of the neural network training method according to various embodiments of the present disclosure described in the part “exemplary method” of this specification.

The computer-readable storage medium may be any combination of one or more readable media. The readable medium may be a readable signal medium or a readable storage medium. The readable storage medium may comprise, but is not limited to, a system, apparatus, or device of electric, magnetic, optic, electromagnetic, infrared, or semiconductor or a combination thereof, for example. More specific examples (non-exhaustive list) of readable storage medium comprise: electrical connections with one or more wires, portable disks, hard disks, random access memory (RAM), read-only memory (ROM), erasable programmable read only memory (EPROM or flash memory), optical fiber, portable compact disk read only memory (CD-ROM), optical storage device, magnetic storage device, or any suitable combination of the above.

The basic principles of the present disclosure have been described above in conjunction with specific embodiments. However, it should be pointed out that the advantages, merits, effects, etc. mentioned in this disclosure are only examples and not limitations. These advantages, merits, effects, etc. cannot be considered as essential for each embodiment of this disclosure. In addition, the specific details disclosed above are only for illustrative purposes and ease of understanding, rather than limitations, and the above application is limited that it has to use the implementation of the above specific details.

The block diagrams of the devices, apparatuses, equipment, and systems involved in this disclosure are merely illustrative examples and are not intended to require or imply that they must be connected, arranged, and configured in the manner shown in the block diagrams. As those skilled in the art will recognize, these devices, apparatuses, equipment, and systems can be connected, arranged, and configured in any manner. Words such as “comprise”, “include”, “have”, etc. are open vocabulary and mean “comprising but not limited to”, and can be used interchangeably with it. The terms “or” and “and” as used herein refer to the terms “and/or” and can be used interchangeably with it, unless the context clearly indicates otherwise. The terms “such as” and “for example” used herein refers to the phrase “for example but not limited to” and can be used interchangeably with it.

It should also be pointed out that in the apparatus, device, and method of the present disclosure, each component or each step can be decomposed and/or recombined. The decomposition and/or recombination shall be regarded as equivalent solutions of this disclosure.

The above description of the disclosed aspects is provided to enable any person skilled in the art to make or use this disclosure. Various modifications to these aspects are very obvious to those skilled in the art, and the general principles defined herein can be applied to other aspects without departing from the scope of the present disclosure. Therefore, the present disclosure is not intended to be limited to the aspects shown here, but shall be interpreted in accordance with the widest scope consistent with the principles and novel features disclosed herein.

The above description has been given for the purposes of illustration and description. In addition, this description is not intended to limit the embodiments of the present disclosure to the form disclosed herein. Although a number of exemplary aspects and embodiments have been discussed above, those skilled in the art will conceive of certain variations, modifications, changes, additions, and subcombinations thereof.

1. A neural network training method, comprising:
inputting training data into a trained first neural network and a to-be-trained second neural network;
determining a first feature map output by a preset layer of the first neural network and a second feature map output by the second neural network at the preset layer;
determining a first loss function value of the second neural network based on the first feature map and the second feature map; and
updating parameters of the second neural network based on the first loss function value and a second loss function value of the second neural network; and
using the updated parameters of the second neural network as initial parameters of the to-be-trained second neural network, repeating in an iterative manner the step of inputting the training data into the trained first neural network and the to-be-trained second neural network to the step of updating the parameters of the second neural network based on the first loss function value and the second loss function value of the second neural network, and obtaining a final trained second neural network when the second neural network obtained after updated meets a preset condition.

2. The neural network training method of claim 1, wherein:
determining the first feature map output by the preset layer of the first neural network and the second feature map output by the second neural network at the preset layer comprises:
determining the feature map output by a last layer of convolutional layers of the first neural network as the first feature map; and,
determining the feature map output by a last layer of convolutional layers of the second neural network as the second feature map;
determining the first loss function value of the second neural network based on the first feature map and the second feature map comprises:
determining a L2 loss function value of the second neural network based on the first feature map and the second feature map; and
determining the first loss function value of the second neural network based on the L2 loss function value.

3. The neural network training method of claim 1, wherein:
determining the first feature map output by the preset layer of the first neural network and the second feature map output by the second neural network at the preset layer comprises:
determining the feature map output by a softmax layer of the first neural network as the first feature map; and,
determining the feature map output by a softmax layer of the second neural network as the second feature map;
determining the first loss function value of the second neural network based on the first feature map and the second feature map comprises:
determining a cross-entropy loss function value of the second neural network based on the first feature map and the second feature map; and
determining the first loss function value of the second neural network based on the cross-entropy loss function value.

4. The neural network training method of claim 1, wherein,
updating the parameters of the second neural network based on the first loss function value and the second loss function value of the second neural network comprises:
calculating a cross-entropy loss function value of the second neural network as the second loss function value;
calculating a weighted sum of the first loss function value and the second loss function value as a total loss function value; and
updating the parameters of the second neural network in a manner that the total loss function value is backpropagated.

5. The neural network training method of claim 1, wherein, before inputting the training data into the trained first neural network and the to-be-trained second neural network, the neural network training method further comprises:
training the first neural network until the first neural network converges; and
performing Gaussian initialization on the second neural network corresponding to the first neural network.

6-10. (canceled)

11. The neural network training method of claim 1, wherein the training data is an image training set.

12. The neural network training method of claim 1, wherein the first neural network is trained to converge.

13. An electronic device for performing a neural network training method comprising:
a memory configured to store computer program instructions; and
a processor programmed to execute the computer program instructions to cause the electronic device to perform operations including to
input training data into a trained first neural network and a to-be-trained second neural network;
determine a first feature map output by a preset layer of the first neural network and a second feature map output by the second neural network at the preset layer;
determine a first loss function value of the second neural network based on the first feature map and the second feature map; and
update parameters of the second neural network based on the first loss function value and a second loss function value of the second neural network; and
use the updated parameters of the second neural network as initial parameters of the to-be-trained second neural network, repeat in an iterative manner the step of inputting the training data into the trained first neural network and the to-be-trained second neural network to the step of updating the parameters of the second neural network based on the first loss function value and the second loss function value of the second neural network, and obtain a final trained second neural network when the second neural network obtained after updated meets a preset condition.

14. The electronic device of claim 13, wherein
to determine the first feature map output by the preset layer of the first neural network and the second feature map output by the second neural network at the preset layer comprises:
determining the feature map output by a last layer of convolutional layers of the first neural network as the first feature map; and,
determining the feature map output by a last layer of convolutional layers of the second neural network as the second feature map;
to determine the first loss function value of the second neural network based on the first feature map and the second feature map comprises:
determining a L2 loss function value of the second neural network based on the first feature map and the second feature map; and
determining the first loss function value of the second neural network based on the L2 loss function value.

15. The electronic device of claim 13, wherein
to determine the first feature map output by the preset layer of the first neural network and the second feature map output by the second neural network at the preset layer comprises:
determining the feature map output by a softmax layer of the first neural network as the first feature map; and,
determining the feature map output by a softmax layer of the second neural network as the second feature map;
to determine the first loss function value of the second neural network based on the first feature map and the second feature map comprises:
determining a cross entropy loss function value of the second neural network based on the first feature map and the second feature map; and
determining the first loss function value of the second neural network based on the cross-entropy loss function value.

16. The electronic device of claim 13, wherein to update the parameters of the second neural network based on the first loss function value and the second loss function value of the second neural network comprises:
calculating a cross-entropy loss function value of the second neural network as the second loss function value;
calculating a weighted sum of the first loss function value and the second loss function value as a total loss function value; and
updating the parameters of the second neural network in a manner that the total loss function value is backpropagated.

17. The electronic device of claim 13, wherein before inputting the training data into the trained first neural network and the to-be-trained second neural network, the electronic device is further programmed to
train the first neural network until the first neural network converges; and
perform Gaussian initialization on the second neural network corresponding to the first neural network.

18. The electronic device of claim 13, wherein the training data is an image training set.

19. The electronic device of claim 13, wherein the first neural network is trained to converge.

20. A non-temporary computer-readable medium, having computer program instructions stored thereon, the computer program instructions, when executed by a processor, causing the processor to execute the neural network training method comprising:
inputting training data into a trained first neural network and a to-be-trained second neural network;
determining a first feature map output by a preset layer of the first neural network and a second feature map output by the second neural network at the preset layer;
determining a first loss function value of the second neural network based on the first feature map and the second feature map; and
updating parameters of the second neural network based on the first loss function value and a second loss function value of the second neural network; and
using the updated parameters of the second neural network as initial parameters of the to-be-trained second neural network, repeating in an iterative manner the step of inputting the training data into the trained first neural network and the to-be-trained second neural network to the step of updating the parameters of the second neural network based on the first loss function value and the second loss function value of the second neural network, and obtaining a final trained second neural network when the second neural network obtained after updated meets a preset condition.

21. The non-temporary computer-readable medium of claim 20, wherein:
determining the first feature map output by the preset layer of the first neural network and the second feature map output by the second neural network at the preset layer comprises:
determining the feature map output by a last layer of convolutional layers of the first neural network as the first feature map; and,
determining the feature map output by a last layer of convolutional layers of the second neural network as the second feature map;
determining the first loss function value of the second neural network based on the first feature map and the second feature map comprises:
determining a L2 loss function value of the second neural network based on the first feature map and the second feature map; and
determining the first loss function value of the second neural network based on the L2 loss function value.

22. The non-temporary computer-readable medium of claim 20, wherein:
determining the first feature map output by the preset layer of the first neural network and the second feature map output by the second neural network at the preset layer comprises:
determining the feature map output by a softmax layer of the first neural network as the first feature map; and,
determining the feature map output by a softmax layer of the second neural network as the second feature map;
determining the first loss function value of the second neural network based on the first feature map and the second feature map comprises:
determining a cross entropy loss function value of the second neural network based on the first feature map and the second feature map; and
determining the first loss function value of the second neural network based on the cross-entropy loss function value.

23. The non-temporary computer-readable medium of claim 20, wherein,
updating the parameters of the second neural network based on the first loss function value and the second loss function value of the second neural network comprises:
calculating a cross-entropy loss function value of the second neural network as the second loss function value;
calculating a weighted sum of the first loss function value and the second loss function value as a total loss function value; and
updating the parameters of the second neural network in a manner that the total loss function value is backpropagated.

24. The non-temporary computer-readable medium of claim 20, wherein, before inputting the training data into the trained first neural network and the to-be-trained second neural network, the neural network training method further comprises:
training the first neural network until the first neural network converges; and
performing Gaussian initialization on the second neural network corresponding to the first neural network.

25. The non-temporary computer-readable medium of claim 20, wherein the training data is an image training set, and/or the first neural network is trained to converge.
